(19) United States
(12) Patent Application Publication
(10) Pub. No.: US 2017/0156985 A1
(43) Pub. Date: Jun. 8, 2017

(54) PERSONAL ELECTRONIC MEDICATION SAFE

(71) Applicant: Hayley Sebrina Guldan, Enterprise, FL (US)

(72) Inventor: Hayley Sebrina Guldan, Enterprise, FL (US)

(21) Appl. No.: 15/369,468

(22) Filed: Dec. 5, 2016

Related U.S. Application Data
(60) Provisional application No. 62/263,230, filed on Dec. 4, 2015.

(51) Int. Cl. A61J 7/00; B65D 83/04; G06F 19/00

(52) U.S. Cl. CPC A61J 7/0076; G06F 19/3456; G06F 19/3462; B65D 83/0409

(57) ABSTRACT

This invention is to provide a machine to securely store, monitor and dispense prescription drugs in pill form to a specific patient as directed by a doctor. It also intends to be a safe lockbox to prevent unauthorized users and children access to the prescribed medication. This is accomplished with a programmable electronic device, which controls time and dosage quantity, biometric access pad to engage dispensing apparatus and administration of medicine to the patient, GPS tracking and pressure sensors to report theft and tampering. This machine has the potential to end pill prescription drug abuse in patients and greatly reduce the use of these prescriptions for illegal recreation.

### CROSS-REFERENCE TO RELATED APPLICATIONS

This non-provisional application claims benefit of prior provisional application: Personal electronic Medication Safe, application No. 62/263,230

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

The use of narcotics and other controlled substances to treat both acute and chronic pain is sometimes necessary, and greatly increases quality of life for individuals who are suffering from such ailments. However, it is no secret that prescription drug abuse in the United States has reached epidemic proportions. Nearly everyone knows someone, or knows of someone, who is battling prescription drug addiction, or has already died of accidental overdose. Although legislation has placed some restrictions on the distribution of narcotics, and there has been an increase in public awareness of the dangers associated with prescription drug abuse, there is still a need to further regulate the distribution and administration of these drugs in pill form.

### BRIEF SUMMARY OF THE INVENTION

The Personal Electronic Medication Safe is purposed to secure, dispense and monitor the administration of prescription drugs to patients. It includes various programmable devices with established fail safes, check systems, and logs to ensure the administration and verification of the prescribed dose of medication at the appropriate time to a specific individual. The use of this device is intended to eliminate virtually all prescription drug abuse and accidental overdose.

The safe is durable. While in operation, the medication stored inside is inaccessible to any individual except the intended patient, and the medication is only accessible to the patient, one prescribed dose at a time, because of the use of biometric technology. In addition, the medication only accessible to the intended patient at certain time intervals which are programmed by trained medical professionals during the filling or refilling of the safe. The device will operate a minimum of 72 hours and a maximum of two weeks without an external power source. The internal battery may be recharged as needed or the device may remain plugged into a standard 120 VAC receptacle. These devices are compact and light enough to be transported to and from the doctor's office or pharmacy by the patient or primary caregiver. Only by trained medical staff or pharmacy workers can it be programmed to dispense exact medication doses at the prescribed times to a specific individual.

In a home or assisted living setting, in its primary embodiment, the Personal Electronic Medication Safe is a small, automatic locking, electronic safe intended for the secure storage and administration of prescription drugs in pill form. It may be a freestanding unit able to rest on any sturdy, flat surface; some examples include: a table, bookshelf, or countertop, or in a varied design, placed on brackets mounted to a wall. Inside the unit is a programmable device that controls dispensing parameters, and also records and transmits data. Sensors can be strategically located on the inside, outside or on the locking mechanism of the devices to sense, record and report an error in dispensing or possible tampering.

At the time of dispensing, the patient is prompted either audibly or visually to authenticate his or her identity biometrically. Only after the individual has been verified will the machine dispense medication. Once dispensed, the single dose of medication is easily accessed by the patient through a small hinged door or flapper. A digital display clock or timer indicates to the patient the current time and the scheduled time, and/or the time remaining until, the next dose of medication is available. The safe remains securely locked for the entire duration between refills.

No individual will be able to access the medication storage compartment at any time. The electronic safes can only be opened by an authorized filling or monitoring outlets, such as, pharmacies who are connected to a secure server with SLL security and able to receive the 256 or 512-bit encrypted key, or running a P.E.M. S. software interface. The lock is electronic with no secondary manual key.

Once the machine has been accessed and opened, the pharmacy is able to download the dispensing and tamper logs for review. During this time the medication storage compartment inside the safe maybe refilled and the device programmed or reprogrammed to dispense a certain dose at appointed time intervals. For example, 2 pills every 4 hours, or 1 pill every 8 hours. Once programmed, the safe will dispense the medication according to the pharmacy input until the prescription runs out, or the device has been reprogrammed.

Further security measures are easily implemented in another embodiment and may be recommend in instances where highly controlled narcotics are distributed or more scrupulous monitoring is needed. Each free standing device is equipped with a wired or wireless modem and may also include GPS. The safe units could report continuous data to a central monitoring station. The monitoring station would process and analyze the data and report anomalies to the proper channels of authority. For example, if a safe was moved from its location without authorization, or sensors were registering abuse or attempts at forced entry, that information would be transmitted immediately, and the monitoring center would contact the patient, and then report the safe as stolen to the local authorities and disclose the safe's coordinance for immediate recovery of the device.

In another application, twenty-four-hour observation for medication dispensing can also be a very beneficial role for a monitoring center to oversee. For example, it is very difficult to keep track of an Alzheimer's or dementia patient's medications; especially, if they are, still in part, handling their prescriptions themselves. These patients often forget to take their medicine or they take it too often because they forgot they already took it. The monitoring center can track the number of missed doses as well as the number of times a patient tried to access the safe before the scheduled times. If a patient is attempting to access their medicine erratically, or the patient has missed several doses and is not able to be contacted by telephone, the monitoring center can notify health care providers or emergency contacts to check on the individual's well-being.

Although, its primary use is for outpatient care in home and assisted living settings, conceptually it may prove to be advantageous in certain embodiments in hospital environments as well. There is little practicality for the durability of the safe's exterior in a hospital room however, there are many applications for the machines conditionals, dispensing parameters, and biometric verification.

More often than one would expect, family members try to take a more active role than is prudent to aid in the care of their loved one while in the hospital, especially in respect to the administration of pain medicine. For example, if a patient is in a significant amount of pain, the patient may be given an IV and a control which is manually pressed to receive pain medicine on demand (to a certain point, of course). It has been reported that a patient's loved ones will sometimes interfere with the pain treatment plan and activate the administration of pain medicine by pressing the control on behalf of the patient, with or without the patient's conscious knowledge, the loved one reasoning that the action helps the patient to sleep or helps to stay ahead of the pain. This rationale is driven by emotion and hardly logical, yet understandably plausible, but nonetheless, proves to be detrimental to the patient's well-being. When such practices are noticed, nursing staff intervene on the patient's behalf, however not every instances noticed or dealt with immediately. The Personal Electronic Medication Safe's technologies places a biometric lock on the buttons to ensure it is the patient requesting the medicine. Every request for medicine is logged and may be analyzed by doctors to further assist in the patient's care.

### BRIEF DESCRIPTION OF THE SEVERAL VIEWS OF THE DRAWING

FIGS. 1-8, Safe—Front View

a) hinged automatic locking side access door

b) digital display to display current time, time of next scheduled dosage, doses remaining, and indicating lights when medication is available to be dispensed

c) biometric identifier to engage electronic and mechanical dispensing parts

d) upper portion of safe which encloses medication bottle, dispensing disk and gear

e) medication dispenser chute with flapper

f) base of unit which houses programmable arduino device with GPS capability, primary and secondary backup power

FIGS. 2-8, Safe—Side View

e) medication dispenser chute with flapper

f) base of unit which houses programmable arduino device with GPS capability, primary and secondary backup power

g) drive shaft powered by small electric motor controlled by components listed in (f)

h) geared disk driven by (g. drive shaft) which, when engaged, spins disk (j) to dispense medications

i) first of three disk dispensing cap system. Disk is stainless, shaped similar to and threaded exactly like a standard prescription bottle cap with a hole shaped to dispense an specific pill size. Disk is intended to remain stationary once attached to a standard prescription bottle

j) second of three disk dispensing cap. Disk is larger than (i), outer edge id geared to intermesh with (h) and turn when (g) is engaged. Disk has one to four holes. Disk depth and holes are specifically sized for pills being dispensed.

k) third disk of three disk dispensing cap system. Disk is stainless and stationary with hole designed to rest above (e.) medication dispenser chute with flapper and rear of disk grooved to rest on (l. support lip)

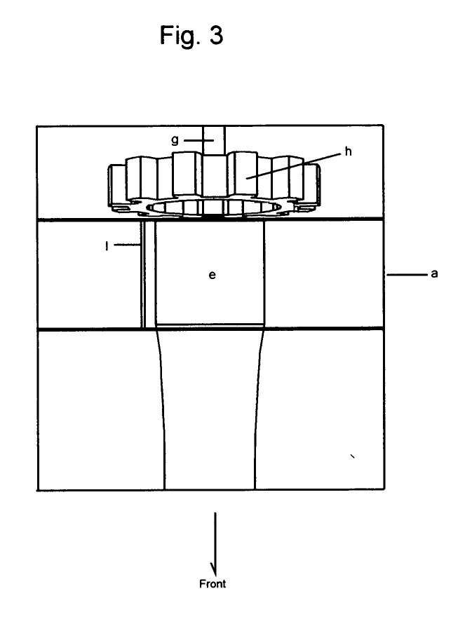

FIGS. 3-8, Safe—Top View

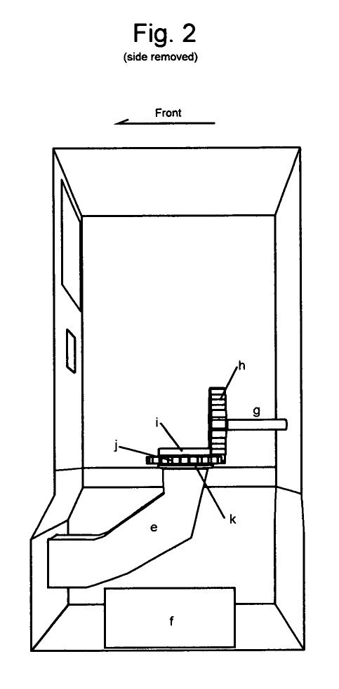

e) described under FIG. 2 of 8

g) described under FIG. 2 of 8

h) described under FIG. 2 of 8

l) support lip intended to support and line up three disk dispensing cap system with the medication chute and (h. geared disk driven by drive shaft)

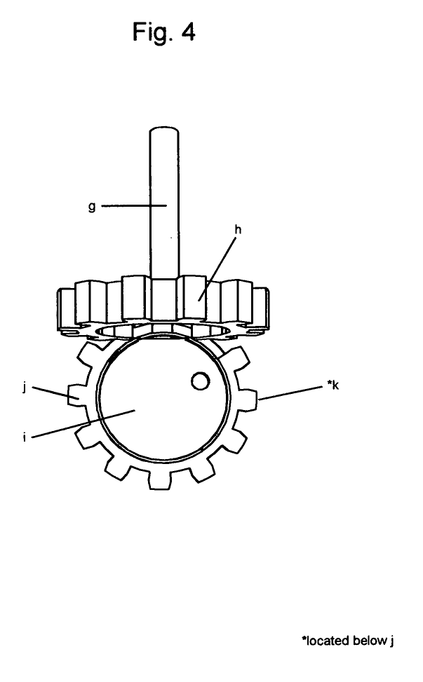

FIGS. 4-8, Dispensing Device—Top View

View from top looking down into safe

g) described under FIG. 2 of 8

h) described under FIG. 2 of 8

i) described under FIG. 2 of 8

j) described under FIG. 2 of 8

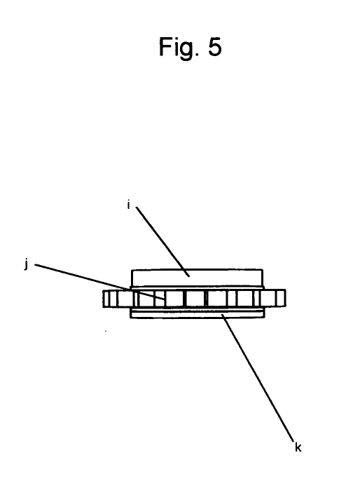

FIGS. 5-8, Dispensing Device—Side View

i) described under FIG. 2 of 8

j) described under FIG. 2 of 8

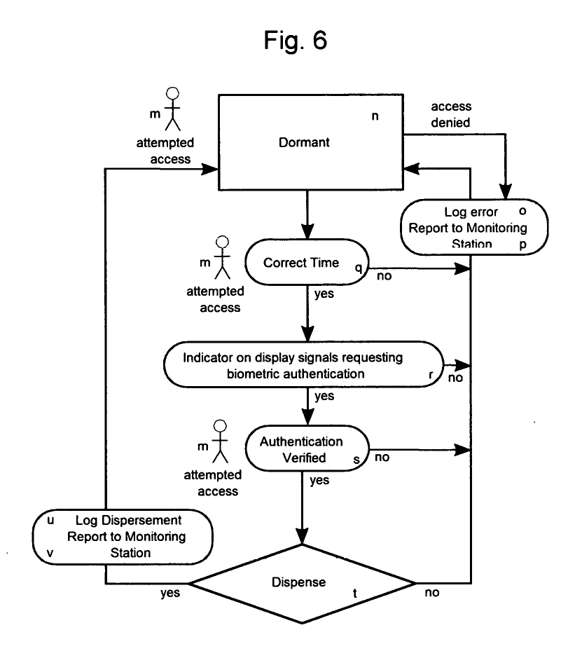

FIGS. 6-8, Flowchart—Embodiment of Controlled Access and the Storing and Reporting Data

m) individual attempting access of medication

n) normal, locked, state of safe

o) internal logging of attempted unauthorized access or error

p) transmission of attempted unauthorized access or error to monitoring station if applicable

q) preprogrammed time medication is scheduled to dispense

r) indication to patient that machine is available to dispense

s) biometric identification

t) disbursement/administration of medicine

u) internal logging of disbursement time and amount of medication dispensed

v) transmission of disbursement time and amount of medication dispensed to monitoring station if applicable

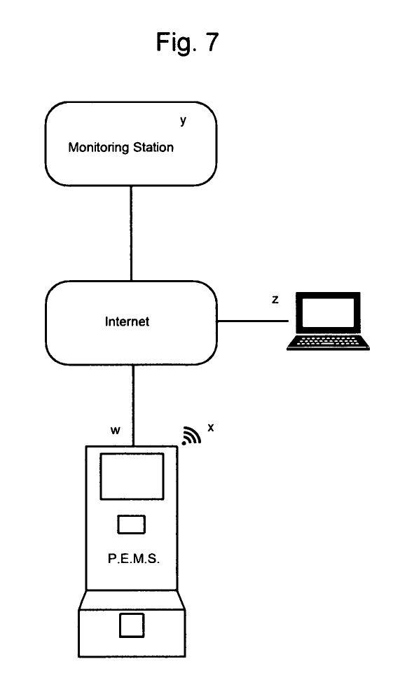

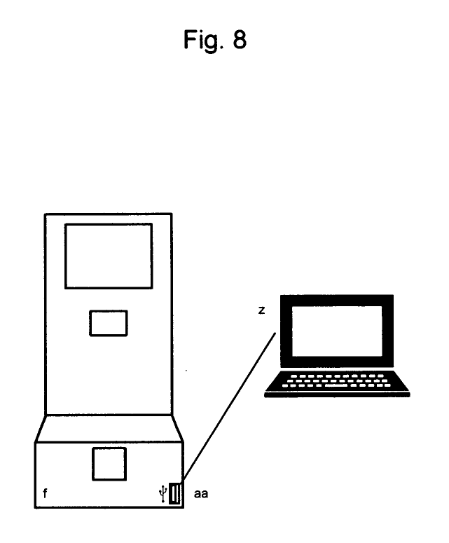

FIGS. 7-8, Chart—Embodiment of Transmission of Data Over the Internet

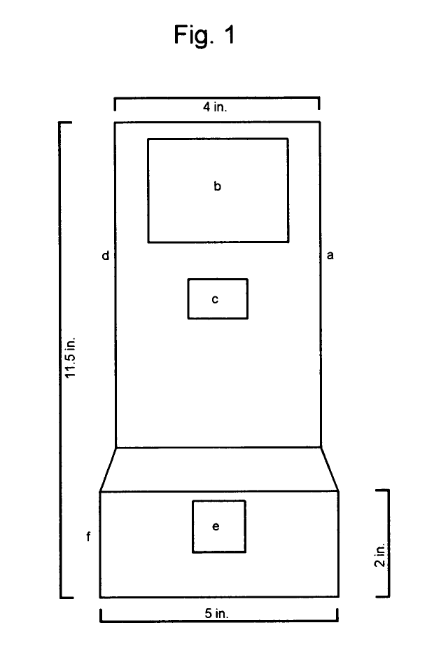

f) described under FIG. 1 of 8

w) optional wired Internet connection

x) optional wireless Internet connection

y) remote monitoring station

z) remote access terminal of authorized refill/programming station (E.g. pharmacy)

FIGS. 8-8, Chart—Embodiment of Embodiment of Transmission of Data Without Internet

f) described under FIG. 1 of 8

z) described under FIG. 7 of 8

aa) USB connection between unit and authorized refill/programming station

### DETAILED DESCRIPTION OF THE INVENTION

Referring to FIG. 1, the P.E.M.S. unit measures 11½″ from base to top. Its exterior is constructed out of ⅜″ high tinsel steel for durability and strength yet the total weight of the unit is less than 10 lbs. The base (f) houses the majority of the electronic components and is the widest part of the safe to ensure stability. The base (f) measures 5″ wide by 5″ deep by 2″ high. From the top of the base (f), the safe is slightly tapered where the patient may access the dispensed prescription pills through a small hinged door or flap (e) at the end of the medication dispensing chute. From that point, the safe narrows into the compartment that secures the prescribed drugs (d) and dispenses medication. The storage compartment (d) is 4″ wide by 4″ deep by 8″ high. It can be accessed by a pharmacist during the time of refilling and programming at the side by a hinged door (a) with an automatic lock. Pressure sensors (not shown) may be installed by the lock, along the sides, around the dispensing chute and base to record possible tampering. All of these electronic parts can be controlled and operated by a programmable arduino device run by P.E.M. S. operating software located in the base (f) of the safe. This device is password protected accessible by a USB port located at the back of the base (f) next to the power cord or an internal router with Internet connection. Only by accessing the arduino device will the safe door be unlocked.

In addition to housing the arduino device, the base (f) will also hold up to two weeks of rechargeable back up battery power and an optional GPS tracking and monitoring devices to further prevent theft.

At the appointed times for the administration of medication, the display (b) located on the front of the safe above the biometric authorization point (c), which digitally displays the current time and date, the time of next scheduled dose, and number of doses remaining before refill. The digital display (b) also has two indicator lights, one red, signifying the safe is inaccessible, and one green, indicating the safe is available to access the next scheduled dose. An audio alarm will beep and the green indicator light will turn on when the preprogrammed time of dispensing occurs. Only then can patient initiate biometric authorization (c) to engage the motor, drive shaft and gear which drives the dispensing cap system. If too many attempts are made to access the medicine at the inappropriate times the safe will lock down and have to be reset manually at the pharmacy or rest by a remote monitoring station via the Internet.

FIG. 2 depicts a side view of the safe with exterior side removed to reveal the dispensing mechanisms. The storage compartment (d) is intended to hold standard sized plastic prescription bottles sealed with a three-part dispensing cap (i,j,k) and inserted into the machine upside down. Each cap is pill specific. The first part of the cap (i) is fixed and screws onto the pill bottle much like a regular prescription pill cap but has an opening shaped to allow one particular sized pill to fall through the opening into the second part of the cap system (j). This second part is a geared disc able to spin independently of the other two discs in the dispensing cap system. It has an opening and a measured depth which is engineered to allow one pill of a certain size into the aperture. Once a pill is picked up by the slow spinning disc (j), it is carried around to a final hole located in the third (bottom) stationary disc (k) which then deposits the pill into a dispensing chute. The dispensing chute may be equipt with a lazer counting apparatus to ensure the correct dosage has been dispensed. The pills bottle, with attached discs, will rest on a lip located slightly above the dispensing chute and the second disc (j) aligning with a gear (h) that is attached to a drive shaft (g) with small motor mounted on the inside rear wall of the safe. When all of the proper conditionals are met, the motor will engage and the gear (h) and turn the center disc (j) of the cap one complete turn for every pill dispensed. For example, if a prescription is written for one pill every eight hours and all conditionals are met, the gear (h) will turn the center disc (j) one complete turn every eight hours, thus dispensing the proper amount of medication according to doctor's orders. If a prescription is written for two pills every four hours, and all conditionals are met, the gear (h) will turn the center disc (j) two complete turns every four hours, again dispensing the proper amount of medication according to doctor's orders.

Furthermore, because of the flexibility of programming, the unit has the capacity to dispense medication on an as needed basis. For example, if a prescription is written for one to two pills every four hours as needed, and all conditionals are met, when biometric identification is verified, the gear (h) will turn the center disc (j) one turn, dispensing one pill. The patient has the option to reenter biometric identification in order to request the disbursement of a second pill. Once identification is verified, the gear (h) will turn the center disc (j) one complete turn to dispense the second pill. The programming the unit receives from the pharmacy will determine how long the patient has access to any remain dose of medication not dispensed initially and whether the next dose of medication is contingent on the first disbursement of medication or the second.

FIG. 3 is a top view of the safe with exterior top removed without medication bottle or cap. Visible from the top, is the gear (h) and shaft (g) as well as the support lip (1) intended to support and line up three disc dispensing cap system (i,j,k) with the medication chute (e) Also visible in this view is the hinged automatic locking side access door (a) which is used by the pharmacy to refill or replace the medication bottle.

FIG. 4 illustrates the top view of the dispensing system inside the safe which includes the drive shaft (g), side mounted gear (h), and the three disc dispensing cap system (i,j,k). The center disc (j) is wider in diameter than the other two discs in the cap system. The larger diameter allows center disc (j) to intermesh with the side mounted gear (h) without impedance. When engaged, gear (h) can turn center disc (j) freely to dispense medication.

FIG. 5 is a sketched image of the three-part cap system. The first disc (i) of the three disc dispensing cap system is stainless, shaped similar to and threaded exactly like a standard prescription bottle cap with a hole shaped to dispense a specific pill size. This disc is two inches in diameter and intended to remain stationary once attached to a standard prescription bottle. Directly below first disc is a thin nylon bushing two inches in diameter placed to create space between the first disc (i) and the second disc (j). The second disc (j) is larger than first disc (i) is geared, and able to spin without impedance. It measures three inches in diameter and is turned by gear (h)(not pictured). Similar to the first disc (i), second disc (j) has a hole shaped to dispense a specific pill size. In addition to specific hole size, the second disc (j) has a specific depth that coincides with the size of the pill being dispensed. The specific depth of second disc (j) ensures that only one pill will be dispensed at a time. Directly below the second disc (j) is a thin nylon bushing two inches in diameter placed to create necessary space between second disc (j) and third disc (k). Third disc (k) is stainless and stationary with a hole designed to rest above the medication dispenser chute with flapper (e.)(not shown) and rear of disc grooved to rest on support lip (1) (not shown). A pill is dispensed by travelling through the hole in first disc (i) into the hole of second disc (j). As second disc (j) turns, the pill travels around until it reaches the hole in third disc (k). The pill then travels through the third disc (k) hole and falls into the medication dispenser chute with flapper (e.) (not shown).

Referring now to FIG. 6, which is the process of controlled access and the storing and reporting of data. The only means of dispensing medication is through biometric authentication. The unit remains locked and inaccessible (n) to any person, including the patient (m) at all times except the times programmed for dispense (E.g. every 4 hours). If any individual attempts to dispense medication at an inappropriate time (n), the machine identifies the attempts as either patient or non-patient request and logs the attempt(s) in the database(o). The unit can be programmed to ‘time out’ after a define number of unsuccessful attempts and require to be rest by a pharmacy or primary care provider. If applicable, the logged attempt(s) will be sent to a monitoring station (p) via wired or wireless Internet connection. The monitoring station could take further action by contacting the patient care provider or law enforcement if repeated attempts are registered.

When a predetermined time is reached (q) the unit will request biometric authorization (r). The machine identifies the attempt as either patient or non-patient request and logs the attempt in the database(o). If authentication is not verified, the machine remains locked and will not dispense. The machine identifies the attempt(s) and logs the attempt(s) in the database(o). If applicable, the logged attempts will be sent to a monitoring station (p) via wired or wireless Internet connection. The monitoring station could take further action by contacting the patient care provider or law enforcement if repeated attempts are registered. The unit can be programmed to ‘time out’ after a define number of unsuccessful attempts and require to be rest by a pharmacy or primary care provider. If authentication is verified (s) the machine will dispense (t) the medication and log the action in the database (u). If applicable, the logged attempts will be sent to a monitoring station (v) via wired or wireless Internet connection.

Each time a pill is dispensed (t), it is logged electronic for immediate transmission to a monitoring station (v) or stored (u) to be accessed by a pharmacy at time of the next refilling. The storing and transmittal of attempted access and actual dispensing of medication data may further assist doctors effectuate care for patients and stem the wide spread abuse of narcotics.

Referring now to FIG. 7, the transmission of data between the safe unit, remote monitoring station (y), and pharmacy (z) via wired (w) or wireless (x) Internet connection. This embodiment is preferred and shows all data is encrypted and sent and received through secure servers in the remote monitoring station (y). There are several advantages to this approach because the machines can be monitored and track twenty-four hour a day, seven days a week. The units can be reset remotely negating the need for a patient to take the unit to a pharmacy to be reset if a ‘timed out’ error was initiated. Also, prescriptions can be readjusted per doctor's orders at any time based on data collect, allowing larger quantities of pills to be distributed from the pharmacy and fewer patient visits to the doctor and pharmacist.

Finally referring to FIG. 8, the transmission of data between the safe unit and pharmacy (z) or health care provider through the USB port (aa) located at the base (f) of the machine. This model is more cost effect for short term and low level narcotics. At the time of refill, or the expiration of a prescription, the safe is carried to a pharmacy where the access and dispense logs are downloaded and transmitted to health care providers, the safe is reprogrammed, refilled, and reissued.

The invention claimed is:

1) A method of dispensing dosage and verifying proper administration and use of prescribed drugs in pill form, comprising of:
a) storing pills in a locked compartment only accessible by authorized patient and/or assigned caregiver at predefined time intervals, according to doctor's prescription, in predetermined doses, according to doctor's prescription;
b) authenticating authorized patient/caregiver with biometric technologies and logging and/or transmitting access;
c) denying unauthorized individuals access to medication and logging and/or transmitting attempted access
d) displaying time of next dispensing and amount of medication remaining
e) generating an audio and/or visual signal causing a patient/caregiver to become aware that medication is available for scheduled dispense;
f) delivering single measured dose of housed medication by automated means.

2) All three and four part pill bottle dispensing cap systems each designed for specific pill size.
